(19) United States
(12) Patent Application Publication
(10) Pub. No.: US 2026/0340829 A1
(43) Pub. Date: Oct. 29, 2026

(54) LIVE CELL PROFILING ASSAY

(71) Applicant: AMGEN INC., Thousand Oaks, CA (US)

(72) Inventors: Yu Yuan, Thousand Oaks, CA (US); Tony Y. Wang, Tiverton, RI (US)

(21) Appl. No.: 19/107,784

(22) PCT Filed: Aug. 23, 2023
(86) PCT No.: PCT/US2023/030906

§ 371 Date: Feb. 28, 2025

Related U.S. Application Data
(60) Provisional application No. 63/402,241, filed on Aug. 30, 2022.

(51) Int. Cl. G06T 7/00; G06T 7/10

(52) U.S. Cl. CPC G06T 7/0016; G06T 7/10; G06T 2207/10056; G06T 2207/10064; G06T 2207/30024

(57) ABSTRACT

A method is provided, comprising: analyzing a first image, captured by a bright-field microscope, of cells distributed between pen regions, using an image segmentation technique to identify areas corresponding to cell locations in the first image; generating a first mask based on the identified areas corresponding to cell locations; generating a image mask, corresponding to locations without cells in the first image; applying the first mask and the second mask to a second image, captured by a fluorescence microscope, including the same cells distributed between the same pen regions; analyzing the second image to determine an indication of a first pixel intensity corresponding to the first mask for each pen region, and a second pixel intensity corresponding to the second mask for each pen region; and identifying indications of cell populations of each of the pen regions based on the first and second pixel intensities for each pen region.

### CROSS-REFERENCE TO RELATED APPLICATIONS

The present application claims priority to U.S. Provisional App. No. 63/402,241, entitled “Live Cell Profiling Assay” and filed Aug. 30, 2022, the entirety of which is incorporated by reference herein.

### FIELD OF THE DISCLOSURE

The present disclosure generally relates to techniques for cell imaging and, more particularly, to live cell assay techniques that allow for profiling of cells based on cellular attributes such as organelle content, organelle activity, or stress response, to support early clone selection and characterization.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The Berkeley Lights Inc. (BLI) Beacon® platform is a fully integrated nanofluidic cell culture system that enables researchers to simultaneously culture, assay and monitor growth of up to 1758 isolated clonal cell lines on nanofluidic chip. The BLI platform offers promising solutions for advancing cell line development operations by enabling selection of clonal cell lines as early as on a single cell level and selection for candidates displaying desired attributes.

### SUMMARY

In an embodiment, a computer-implemented method is provided, comprising: obtaining, by one or more processors, a first image captured by a bright-field microscope having a first field of view including one or more cells distributed between one or more pen regions; obtaining, by the one or more processors, a second image captured by a fluorescence microscope having a second field of view including the one or more cells distributed between the one or more pen regions; analyzing, by one or more processors, the first image using an image segmentation technique to identify areas in the first image corresponding to locations of cells; generating, by the one or more processors, a first image mask based on the identified areas in each of the pen regions of the first image corresponding to locations of cells; generating, by the one or more processors, a second image mask, corresponding to locations without cells in each of the pen regions of the first image, based on inverting the first image mask; applying, by the one or more processors, the first image mask and the second image mask to the second image; analyzing, by the one or more processors, each of the pen regions of the second image to determine an indication of a first pixel intensity corresponding to the first image mask for each pen region, and a second pixel intensity corresponding to the second image mask for each pen region; and identifying, by the one or more processors, an indication of a cell population of each of the one or more pen regions based on the first pixel intensity and the second pixel intensity.

In another embodiment, a system is provided, comprising: one or more pen regions; a bright-field microscope having a first field of view including one or more cells distributed between one or more pen regions, configured to capture a first image; a fluorescence microscope having a second field of view including the one or more cells distributed between the one or more pen regions, configured to capture a second image; one or more processors; and a memory storing non-transitory, computer-readable instructions, that, when executed by the one or more processors, cause the one or more processors to: analyze the first image using an image segmentation technique to identify areas in the first image corresponding to locations of cells; generate a first image mask based on the identified areas in each of the pen regions of the first image corresponding to locations of cells; generate a second image mask, corresponding to locations without cells in each of the pen regions of the first image, based on inverting the first image mask; apply the first image mask and the second image mask to the second image; analyze each of the pen regions of the second image to determine an indication of a first pixel intensity corresponding to the first image mask for each pen region, and a second pixel intensity corresponding to the second image mask for each pen region; and identify an indication of a cell population of each of the one or more pen regions based on the first pixel intensity and the second pixel intensity.

In yet another embodiment, a non-transitory, computer-readable medium is provided, storing instructions that, when executed by one or more processors, cause the one or more processors to: obtain a first image captured by a bright-field microscope having a first field of view including one or more cells distributed between one or more pen regions; obtain a second image captured by a fluorescence microscope having a second field of view including the one or more cells distributed between the one or more pen regions; analyze the first image using an image segmentation technique to identify areas in the first image corresponding to locations of cells; generate a first image mask based on the identified areas in each of the pen regions of the first image corresponding to locations of cells; generate a second image mask, corresponding to locations without cells in each of the pen regions of the first image, based on inverting the first image mask; apply the first image mask and the second image mask to the second image; analyze each of the pen regions of the second image to determine an indication of a first pixel intensity corresponding to the first image mask for each pen region, and a second pixel intensity corresponding to the second image mask for each pen region; and identify an indication of a cell population of each of the one or more pen regions based on the first pixel intensity and the second pixel intensity.

### BRIEF DESCRIPTION OF THE DRAWINGS

FIG. 1 illustrates example live cell assays that are commercially available and can be optimized for on-chip staining, in accordance with some examples provided herein.

FIGS. 2A and 2B illustrate on-chip staining utilizing a fluorescently labelled mitochondrial activity marker (Rh123) demonstrating a spectrum of metabolic activity phenotypes observed among population of clones grown on chip, in accordance with some examples provided herein.

FIG. 3 illustrates example steps executed during on-chip Rh123 staining assay, in accordance with some examples provided herein.

FIG. 4 illustrates a first example independent image-based method employed to identify areas populated by cells in each pen and used to measure fluorescence intensity, in which a blank assay is run prior to loading the cells, in accordance with some examples provided herein. The equations displayed reflect components contributing to the raw signal and were applied during background correction step.

FIG. 5 illustrates graphs demonstrating raw mean fluorescence intensity and corrected mean fluorescence intensity values for each pen using the method shown at FIG. 4, in which a blank assay is run prior to loading the cells, in accordance with some examples provided herein.

FIG. 6 illustrates a first example independent image-based method employed to identify areas populated by cells in each pen and used to measure fluorescence intensity, in which an in-pen normalization step using the collected images is performed after the assay is complete, in accordance with some examples provided herein. The equations displayed reflect components contributing to the raw signal and were applied during background correction step.

FIG. 7 illustrates graphs demonstrating raw mean fluorescence intensity and corrected mean fluorescence intensity values for each pen using the method shown at FIG. 6, in which an in-pen normalization step using the collected images is performed after the assay is complete, in accordance with some examples provided herein.

FIG. 8 illustrates a correlation of normalized Rh123 signal generated by methods illustrated at FIGS. 4 and 6, in accordance with some examples provided herein.

FIG. 9 illustrates a system for implementing live cell assay techniques that allow for profiling of cells based on cellular attributes such as organelle content, organelle activity, or stress response, to support early clone selection and characterization, in accordance with some examples provided herein.

FIG. 10A illustrates examples of image masks as applied to an image of pens containing cells captured by a bright-field microscope, while FIG. 10B illustrates examples of the same image masks applied to an image of pens containing cells captured by a fluorescence microscope, in accordance with some examples provided herein.

FIG. 11 illustrates a live cell assay method for profiling of cells based on cellular attributes such as organelle content, organelle activity, or stress response, to support early clone selection and characterization, as may implemented by the system of FIG. 9, in accordance with some examples provided herein.

### DETAILED DESCRIPTION

### Overview

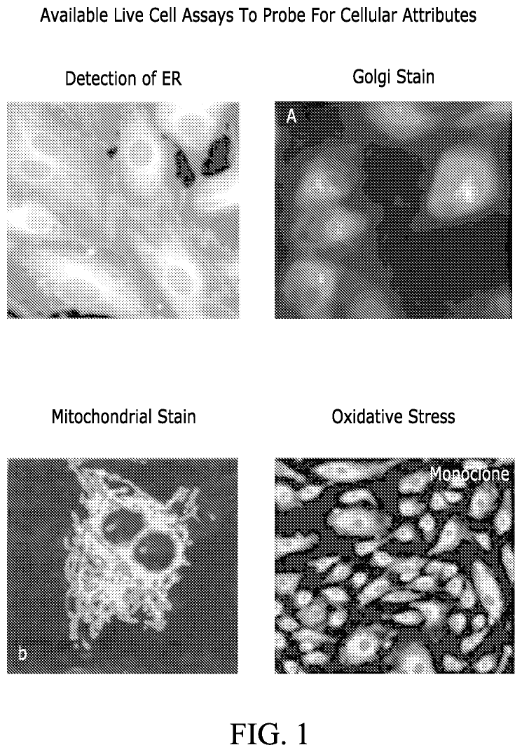

The Berkeley Lights Inc. (BLI) platform has a built-in fluorescent microscope equipped with 4 filter cubes, presenting an opportunity to develop multiplex live cell assays and profile cells based on cellular attributes such as organelle content, organelle activity or stress response. FIG. 1 illustrates example live cell assays that are commercially available and can be optimized for on-chip staining, in accordance with some examples provided herein. For example, FIG. 1 illustrates a stain that can be used to detect endoplasmic reticulum (ER) stress, a golgi stain, a mitochondrial stain, and an oxidative stress stain. The example stains shown at FIG. 1 are not intended to be limiting, as many types of on-chip staining are available. In any case, development of such assays will require optimization of on-chip staining protocols as well as developing image-based scoring strategies to measure changes detected on captured images.

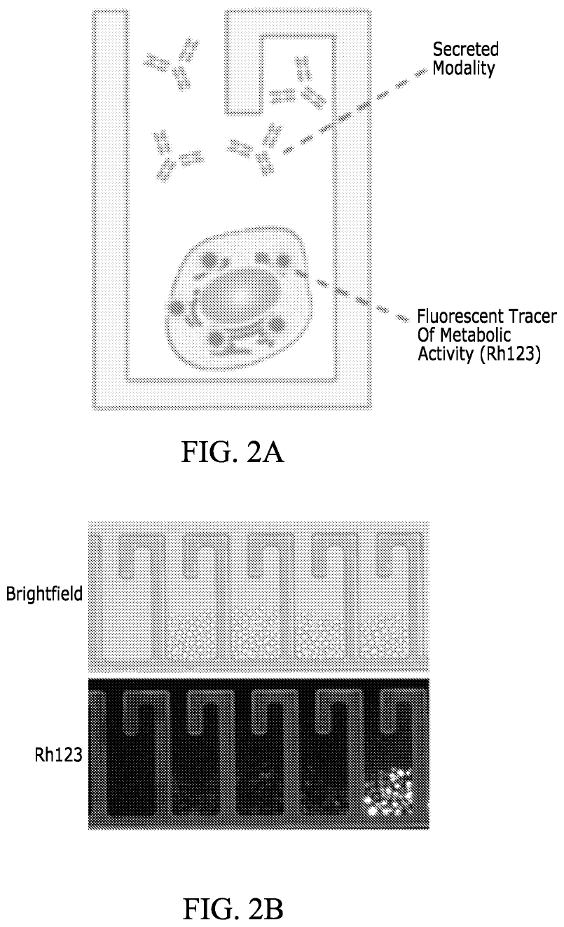

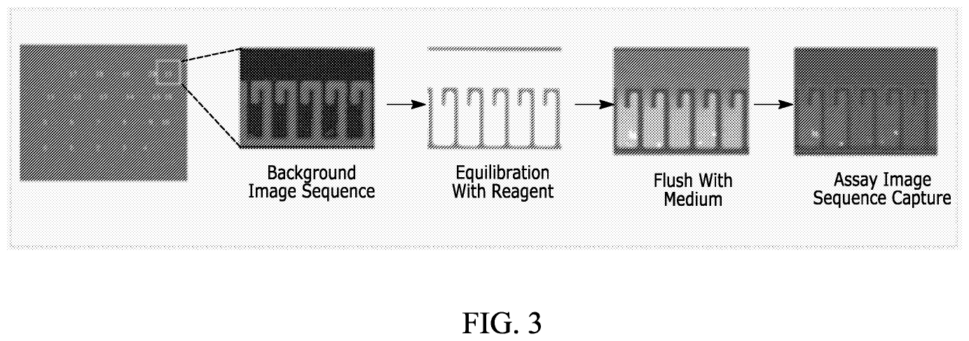

The present disclosure provides a protocol compatible with the BLI platform that will allow cells to be profiled based on their metabolic activity. In one example, as shown in FIG. 2A, Rhodamine123, a cell-permeant, cationic fluorophore conjugated dye that accumulates in active mitochondria without cytotoxic effects, was utilized to assess mitochondrial membrane potential, a known indicator of cellular metabolic activity. FIG. 2B illustrates a comparison of example bright-field microscope and fluorescence microscope images for cells in pens treated with Rhodamine 123, demonstrating a spectrum of metabolic activity phenotypes observed among population of clones grown on chip, in accordance with some examples provided herein.

An image-based analysis method was developed to score fluorescence intensity of cells stained on a chip. An image-based algorithm was developed, using a bright-field image sequence to identify areas populated by cells and generate a pseudo colored mask. The mask is then applied to corresponding fluorescence images in order to measure fluorescence intensity of individual clones grown on chip.

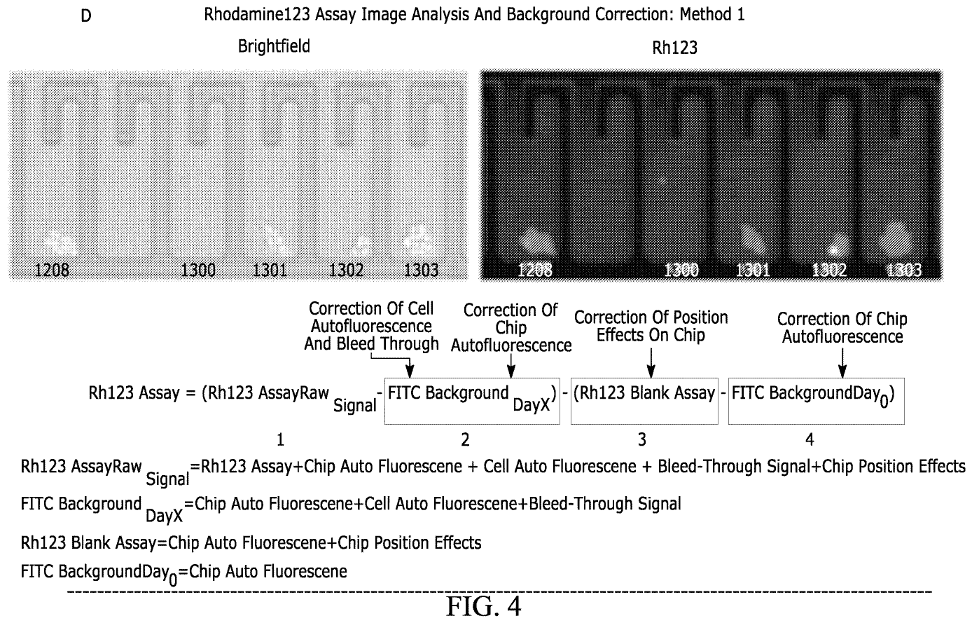

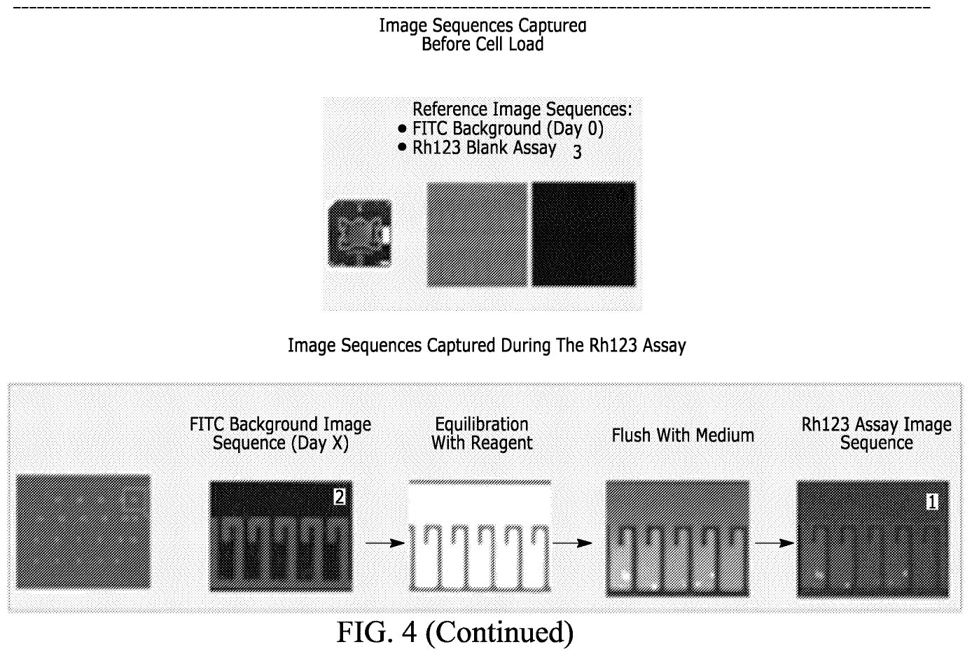

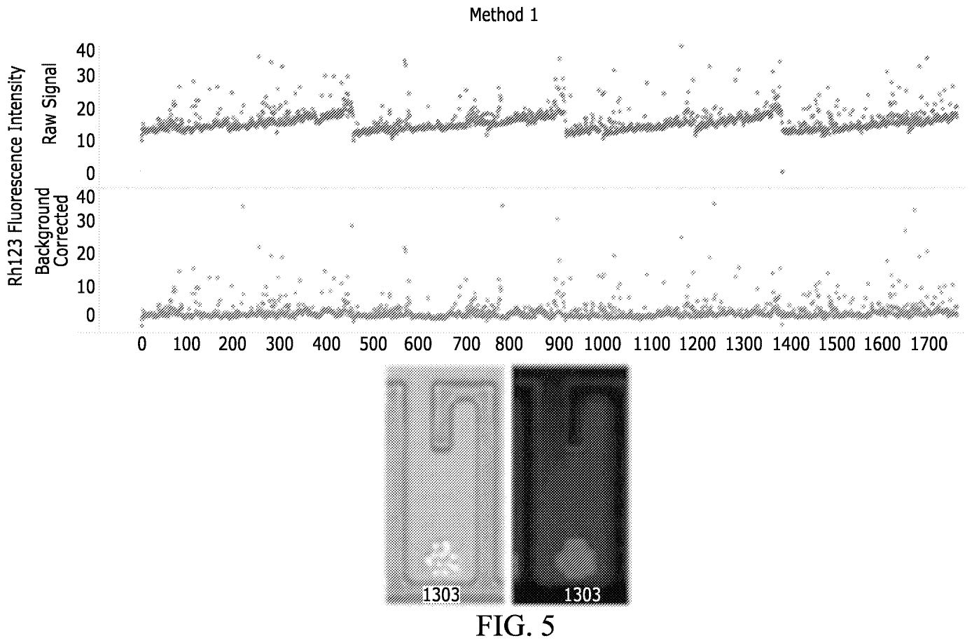

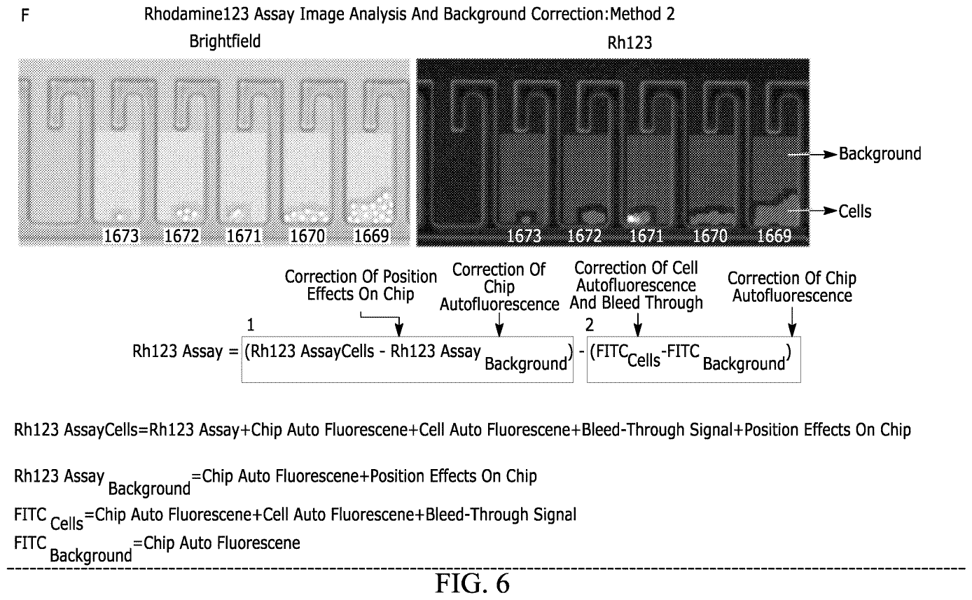

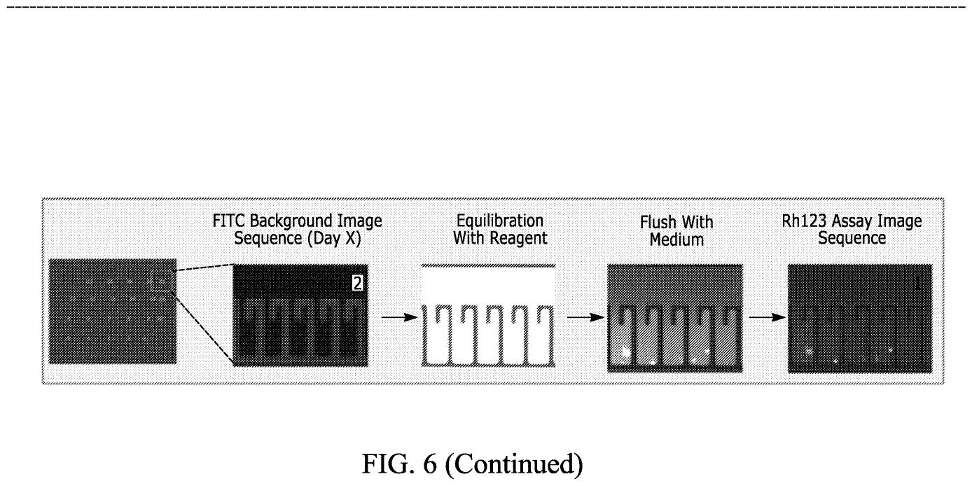

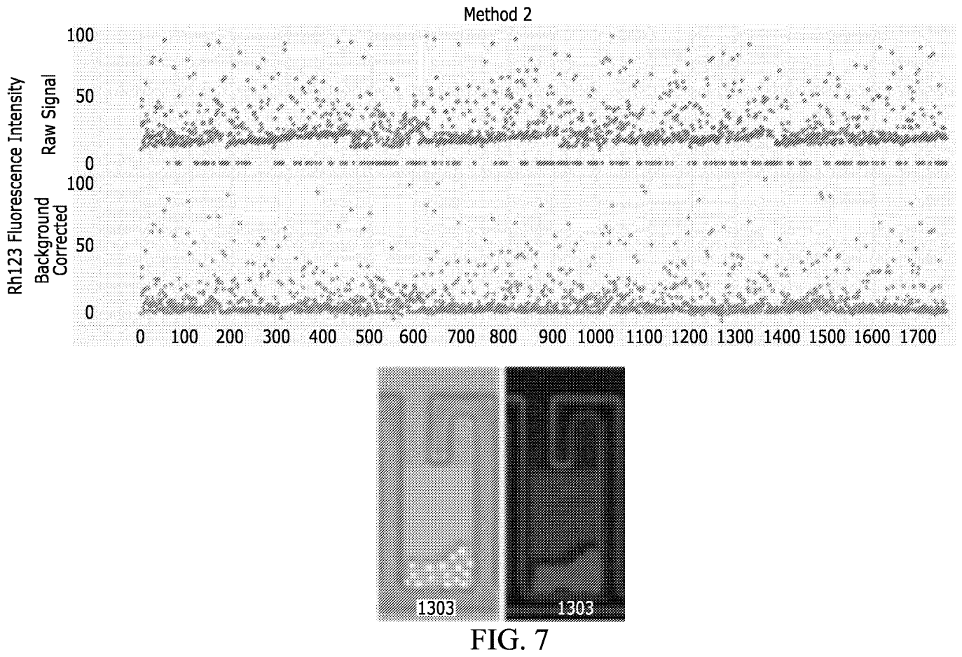

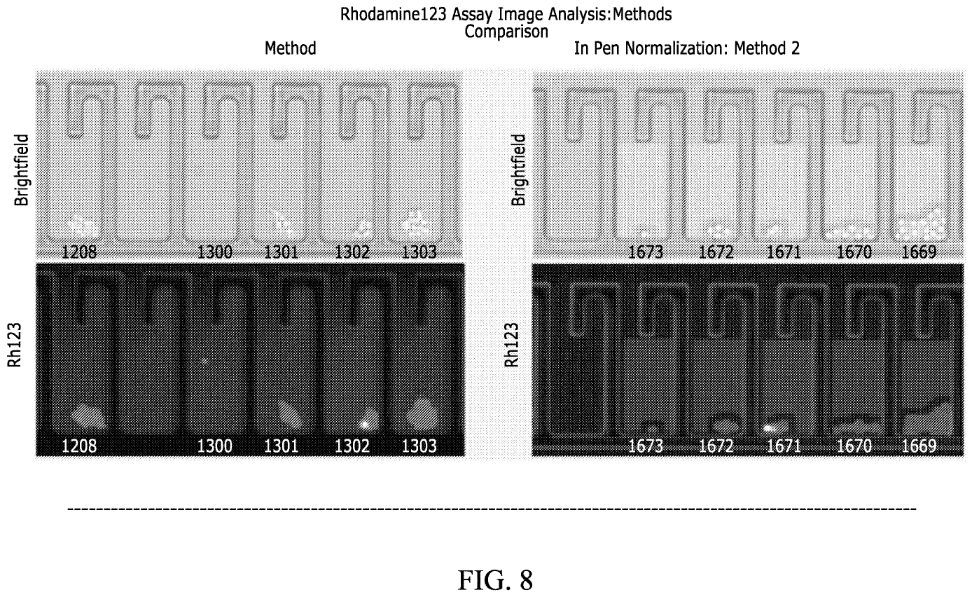

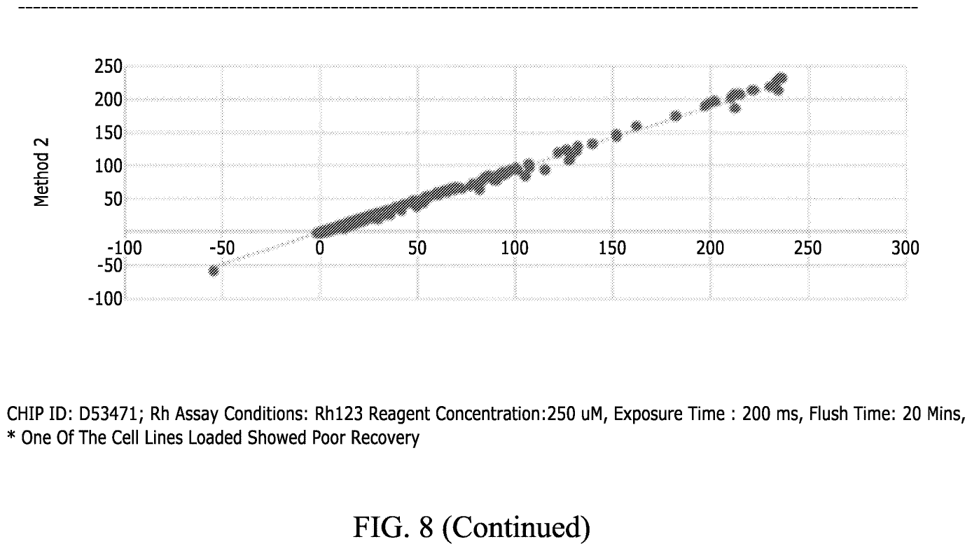

During data analysis, it was discovered that the raw signal measured for each chip subjected to analysis displayed chip position effects driven by the orientation of fluidic channels and insufficient flushing. To correct for these effects, two background correction strategies were developed, either a blank assay was run prior loading the cells, as shown with respect to FIGS. 4 and 5, or an in-pen normalization step was performed using an image sequence collected after completion of the assay, as shown with respect to FIGS. 6 and 7. Both methods allowed for successful removal of the background driven by chip position effects. Moreover, the two normalization methods discussed herein demonstrate very good correlation, as shown at FIG. 8.

The background correction strategy in which a blank assay is run prior to loading the cells, as shown at FIGS. 4 and 5, may use the following equation:

Rh123 Assay=(Rh123AssayRaw_{signal}−FITC Background_{Dayx})−(Rh123BlankAssay−FITC Background_{Day0}), where:

Rh123AssayRaw_{signal}=Rh123Assay+Chip autofluorescence+Bleed−through signal+Chip Position Effects;

FITC Background_{DayX}=Chip autofluorescence+Cell autofluorescence+Bleed−through signal;

Rh123BlankAssay=Chip autofluorescence+Chip position effects; and

FITC Background_{Day0}=Chip autofluorescence.

The background correction strategy in which an in-pen normalization step was performed using an image sequence collected after completion of the assay, as shown at FIGS. 6 and 7, may use the following equation:

Rh123 Assay=(Rh123 AssayCells−Rh123 Assay_{Background})−(FITC_{cells}−FITC_{Background}),

where

Rh123 AssayCells=Rh123 Assay+Chip autofluorescence+Bleed-through signal+Position effects on chip;

Rh123 Assay_{Background}=Chip autofluorescence+Position effects on chip;

FITC_{Cells}=Chip autofluorescence+Cell autofluorescence+Bleed-through signal; and

FITC_{Background}=Chip autoflorescence.

In recent studies CHO cells with enhanced metabolic activity demonstrated increased productivity of therapeutic proteins, however, a clear mechanism is not understood. However, the BLI coupled staining and quantification provides researchers with an opportunity to monitor mitochondrial activity as early as on a single cell level and allows researchers to monitor mitochondrial activity dynamics over time for thousands of clonal cell lines simultaneously. This is in contrast to canonical FACS based technologies. This assay can be used to profile cell lines expressing therapeutic biologics on the BLI platform. Furthermore, the image-based scoring method discussed herein can be extended to other cellular dyes as well (e.g., as shown at FIG. 1.

### Example System

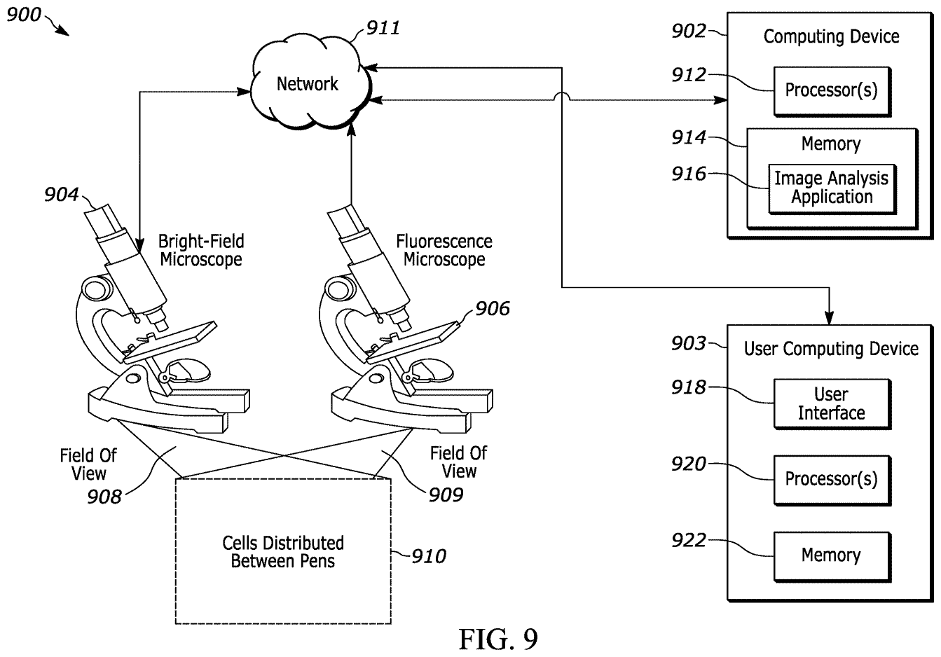

FIG. 9 is a block diagram of a system 900 for implementing live cell assay techniques that allow for profiling of cells based on cellular attributes such as organelle content, organelle activity, or stress response, to support early clone selection and characterization, in accordance with some examples provided herein. The high-level architecture illustrated in FIG. 9 may include both hardware and software applications, as well as various data communications channels for communicating data between the various hardware and software components, as is described below.

The system 900 may include a computing device 902 and one or more user computing device(s) 903, as well as a bright-field microscope 904 and a fluorescence microscope 906. The bright-field microscope 904 and/or the fluorescence microscope 906 may utilize various possible filter cubes, including but not limited to the following filter cubes shown at Tables 1 and 2:

TABLE 1

| Filter Cube | Excitation | Emission |
|---|---|---|
| DAPI | 390/40 | 452/45 |
| | Filter: FF01-390/40 | Filter: FF01-452/45 |
| FITC | 475/50 | 540/50 |
| | Filter: FF02-475/50 | Filter: FF01-540/50 |
| Texas Red | 562/40 | 624/40 |
| | Filter: FF01-562/40 | Filter: FF01-624/40 |
| Cy5 | 628/40 | 692/40 |
| | Filter: FF02-628/40 | Filter: FF01-692/40 |

TABLE 2

| | | Spectral | Filter | Excitation | Dichroic | Barrier |
|---|---|---|---|---|---|---|
| Filter Cube | Excitation | profile | diameter | filter | mirror | filter |
| DAPI | UV | graph | 25 mm | 375/28 | 415 | 435 |
| Fluoro Gold Calcofluor White | UV | graph | 25 mm | 375/28 | 415 | 515 |
| Aqua | V | graph | 25 mm | 420/40 | 455 | 465 |
| GFP/FITC | B | graph | 25 mm | 480/30 | 505 | 515 |
| TRITC/CY3 | G | graph | 25 mm | 540/25 | 565 | 575 |
| DAPI/Hoechst/Alexa Fluor 350 | N/A | graph | 25 mm | 375/28 | 415 | 460/50 |
| ECFP/Cerulean | N/A | graph | 25 mm | 435/20 | 455 | 480/30 |
| EGFP/FITC/Cy2/Alexa Fluor 488 | N/A | graph | 25 mm | 480/30 | 505 | 535/40 |
| EYFP/Venus/Citrine | N/A | graph | 25 mm | 495/20 | 515 | 540/30 |
| TRITC/Cy3/TagRFP/Alexa Fluor 546 | N/A | graph | 25 mm | 540/25 | 565 | 605/55 |
| TRITC (Red Shifted) | N/A | graph | 25 mm | 540/25 | 565 | 620/60 |
| Texas Red/mCherry/Alexa Fluor 594 | N/A | graph | 25 mm | 560/40 | 600 | 635/60 |
| Cy5/AlexaFluor 647/Draq 5 | N/A | graph | 25 mm | 620/50 | 655 | 690/50 |
| DAPI SOLA | N/A | graph | 25 mm | 378/52 | 409 | 447/60 |
| DAPI | N/A | graph | 25 mm | 356/30 | 409 | 447/60 |
| CFP | N/A | graph | 25 mm | 438/24 | 458 | 483/32 |
| GFP/FITC/Cy2 | N/A | graph | 25 mm | 466/40 | 495 | 525/50 |
| YFP | N/A | graph | 25 mm | 500/24 | 520 | 542/27 |
| DS Red/TRITC/Cy3 | N/A | graph | 25 mm | 554/23 | 573 | 609/54 |
| Texas Red/mCherry | N/A | graph | 25 mm | 562/40 | 593 | 641/75 |
| Cy5 | N/A | graph | 25 mm | 618/50 | 652 | 698/70 |
| Cy7 | N/A | graph | 25 mm | 708/75 | 757 | 809/81 |
| DAPI SOLA | N/A | graph | 32 mm | 378/52 | 409 | 447/60 |
| DAPI | N/A | graph | 32 mm | 356/30 | 409 | 447/60 |
| CFP | N/A | graph | 32 mm | 438/24 | 458 | 483/32 |
| GFP/FITC/Cy2 | N/A | graph | 32 mm | 466/40 | 495 | 525/50 |
| YFP | N/A | graph | 32 mm | 500/24 | 520 | 542/27 |
| DS Red/TRITC/Cy3 | N/A | graph | 32 mm | 554/23 | 573 | 609/54 |
| Texas Red/mCherry | N/A | graph | 32 mm | 562/40 | 593 | 641/75 |
| Cy5 | N/A | graph | 32 mm | 618/50 | 652 | 698/70 |
| Cy7 | N/A | graph | 32 mm | 708/75 | 757 | 809/81 |

The bright-field microscope 904 may be configured to capture images over a field of view (FOV) 908 including one or more cells 910 distributed between one or more pen regions, and the fluorescence microscope 906 may be configured to capture images over a FOV 909 including the same one or more cells 910 distributed between the same one or more pen regions. In some examples, the bright-field microscope 904 and the fluorescence microscope 906 may capture images of the same cells 910 at the exact same time, or within a threshold period of time. In some examples, the bright-field microscope 904 and/or the fluorescence microscope 906 may also capture images of the pen regions without the cells 910 (e.g., prior to cells 910 being added to the pens).

The bright-field microscope 904 and the fluorescence microscope 906 may be configured to communicate with the computing device 902 and/or the user computing device(s) 903 via a wired or wireless network 911, e.g., to send captured images to the computing device 902 and user computing device(s) 903.

The computing device 902 may include one or more processors 912 and a memory 914 (e.g., volatile memory, non-volatile memory). The memory 914 may be accessible by the one or more processors 912 (e.g., via a memory controller). The one or more processors 912 may interact with the memory 914 to obtain, for example, computer-readable instructions stored in the memory 914. The computer-readable instructions stored in the memory 914 may cause the one or more processors 912 to execute one or more applications, including an image analysis application 916.

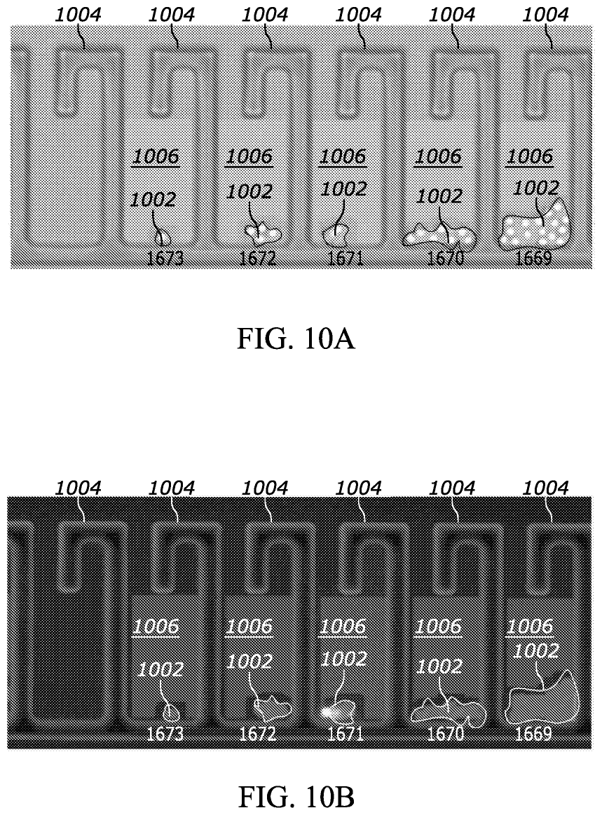

Executing the image analysis application 916 may include obtaining an image captured by the bright-field microscope 904, and obtaining an image captured by the fluorescence microscope 906. In some examples, both images may be captured within a threshold period of time. Additionally, executing the image analysis application 916 may include analyzing the image captured by the bright-field microscope 904 using an image segmentation technique to identify areas in the image corresponding to the locations of cells, and generating a first image mask (also called a “target mask”) based on the identified areas in each of the pen regions of the image corresponding to locations of cells. FIG. 10A illustrates examples of the outlines of the first mask 1002 in each pen 1004. As shown in FIG. 10A, the first mask 1002 (target mask) may be generated to cover a group of cells (or multiple groups of cells) in each pen by segmenting between a group of cells and the background of the pen generally. Consequently, there is no need to utilize computationally complex algorithms to identify each cell individually. Moreover, there is no need to train such algorithms to recognize different types of cells that may be used in the pens.

Furthermore, executing the image analysis application 916 may include generating a second image mask, corresponding to locations without cells in each of the pen regions of the image, based on inverting the first image mask within each pen. FIG. 10A illustrates examples of the second masks 1006 in each pen 1004. In some examples, generating the second image mask may include expanding the first image mask and inverting the expanded first image mask, i.e., such that the outline of the first mask 1002 does not necessarily align with the outline of the second mask 1006 in each pen.

Additionally, executing the image analysis application 916 may include applying the first image mask 1002 and the second image mask 1006 to the image captured by the fluorescence microscope 906, as shown in FIG. 10B.

Executing the image analysis application 916 may include analyzing each of the pen regions 1004 of the image (with the mask applied) to determine an indication of a first pixel intensity corresponding to the first image mask 1002 for each pen region, and a second pixel intensity corresponding to the second image mask 1006 for each pen region. Executing the image analysis application 916 may also include identifying an indication of a cell population of each of the one or more pen regions based on the first pixel intensity and/or the second pixel intensity.

Moreover, in some examples, executing the image analysis application 916 may include obtaining an additional image of the one or more pen regions captured by the fluorescence microscope, prior to the one or more cells being distributed between the one or more pen regions. In such examples, identifying the indication of the cell population of each of the one or more pen regions may be further based on a third pixel intensity corresponding to each pen region of the additional image. That is, this additional image of the one or more pen regions captured by the fluorescence microscope, prior to the one or more cells being distributed between the one or more pen regions, may be used to determine an indication of pen fluorescence when no cells are in the pens, and the pixel intensity associated with the pen fluorescence may be subtracted from the determined pixel intensity associated with cells within the pen regions.

Additionally, in some examples, executing the image analysis application 916 may include applying the first image mask 1002 and the second image mask 1006 to additional images of the same pen regions 1004 (e.g., images from other microscopes, images with different filters applied, etc.) captured at substantially the same time as the image captured by the bright-field microscope 904, and subsequently determining an indication of a first pixel intensity corresponding to the first image mask 1002 for each pen region, and a second pixel intensity corresponding to the second image mask 1006 for each pen region in order to identify an indication of a cell population of each of the one or more pen regions based on the first pixel intensity and the second pixel intensity.

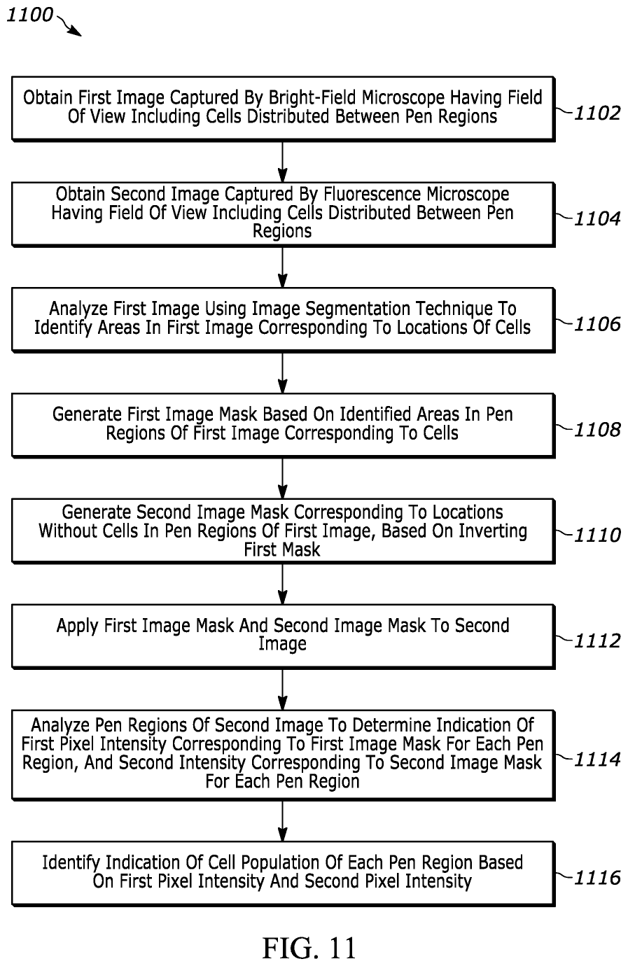

Furthermore, in some examples, the computer-readable instructions stored on the memory 914 may include instructions for carrying out any of the steps of the method 1100, described in greater detail below with respect to FIG. 11.

Moreover, in various aspects, the computing device 902 may comprise a server, or multiple servers, which may comprise multiple, redundant, or replicated servers as part of a server farm. In still further aspects, the computing device 902 may be implemented as cloud-based servers, such as a cloud-based computing platform. For example, the computing device 902 may be any one or more cloud-based platform(s) such as MICROSOFT AZURE, AMAZON AWS, or the like.

Turning now to the user computing device(s) 903, each of the user computing device(s) may include a user interface 918 which may receive input from users and provide audio, visual, or other output to users, one or more processors 920, and a memory 922 (e.g., volatile memory, non-volatile memory). The memory 922 may be accessible by the one or more processors 920 (e.g., via a memory controller). The one or more processors 920 may interact with the memory 922 to obtain, for example, computer-readable instructions stored in the memory 922. The computer-readable instructions stored in the memory 922 may cause the one or more processors 920 to execute one or more applications, including an application via which users may control the capture of images by the bright-field microscope 904 and/or fluorescence microscope 906, e.g., via the user interface 918, and/or an application causing the results of the image analysis application 916 to be displayed via the user interface 918. Moreover, in some examples, the image analysis application 916, or portions thereof, may be stored on the memory 922 and executed by the one or more processors 920 of the user computing device(s) 903.

Furthermore, in some examples, the computer-readable instructions stored on the memory 922 may include instructions for carrying out any of the steps of the method 1100, described in greater detail below with respect to FIG. 11

### Example Method

FIG. 11 is a flow diagram of an example live cell assay method 1100 for profiling of cells based on cellular attributes such as organelle content, organelle activity, or stress response, to support early clone selection and characterization as may be implemented by the system 900 of FIG. 9, in accordance with some examples provided herein. One or more steps of the method 1100 may be implemented as a set of instructions stored on a computer-readable memory (e.g., memory 914 and/or memory 922) and executable on one or more processors (e.g., processors 912 and/or processors 920).

The method 1100 may be begin when a first image is obtained (block 1102). The first image may be captured by a bright-field microscope having a first field of view including one or more cells distributed between one or more pen regions.

A second image may be obtained (block 1104). The second image may be captured by a fluorescence microscope having a second field of view including the one or more cells distributed between the one or more pen regions. In some examples, both the first image and the second image may be captured within a threshold period of time.

The first image may be analyzed (block 1106) using an image segmentation technique to identify areas in the first image corresponding to locations of cells.

A first image mask may be generated (block 1108) based on the identified areas in each of the pen regions of the first image corresponding to locations of cells.

A second image mask may be generated (block 1110), corresponding to locations without cells in each of the pen regions of the first image, based on inverting the first image mask. In some examples, generating the second image mask may include expanding the first image mask and inverting the expanded first image mask.

The first image mask and the second image mask may be applied (block 1112) to the second image.

Each of the pen regions of the second image may be analyzed (block 1114) to determine an indication of a first pixel intensity corresponding to the first image mask for each pen region, and a second pixel intensity corresponding to the second image mask for each pen region.

An indication of a cell population of each of the one or more pen regions may be identified (block 1116) based on the first pixel intensity and the second pixel intensity.

In some examples, the method 1100 may include obtaining an additional image of the one or more pen regions captured by the fluorescence microscope, prior to the one or more cells being distributed between the one or more pen regions. In such examples, identifying the indication of the cell population of each of the one or more pen regions may be further based on a third pixel intensity corresponding to each pen region of the additional image.

### Additional Considerations

The following additional considerations apply to the foregoing discussion.

The development of cell lines expressing recombinant proteins relies on manipulating cells to secrete desired proteins. Successful development of a cell line is a lengthy, multiple step process that includes development of a clonal cell line expressing the desired protein. Typical cell line development processes rely in part on a variety of screening assays to identify and isolate suitable cells to use for development of clonal cell lines, i.e., host cells, that expresses a protein having desired product quality attributes while also conforming to desired manufacturing processes and operations with minimal impact.

Cells used in the present disclosure are genetically engineered to express a recombinant protein of scientific or commercial (e.g., a therapeutic biologic) interest. Cells may be suitable for adherent, monolayer, and/or suspension culture, transfection, and expression of recombinant proteins, such as, e.g., antibodies. The cells can be used, for example, with batch, fed batch, and perfusion or continuous culture methods. Such cells are typically cell lines obtained or derived from mammals and are able to grow and survive when placed in either monolayer culture or suspension culture in medium containing appropriate nutrients and/or other factors, such as those described herein. Cells are typically selected that can express and secrete proteins, or that can be molecularly engineered to express and secrete, large quantities of a particular protein, more particularly, a glycoprotein of interest, into the culture medium. The selection of an appropriate cell for expressing a recombinant protein will depend upon various factors, such as desired expression levels, polypeptide modifications that are desirable or necessary for activity (such as glycosylation or phosphorylation), and ease of folding into a biologically active molecule. In some embodiments of the methods of the present disclosure, the cell is a mammalian cell.

Suitable cells include, but are not limited to, those that are commercially available, for example, from culture collections such as the DSMZ (Deutsche Sammlung von Mikroorganismen and Zellkulturen GmbH, Braunschweig, Germany) or the American Type Culture Collection (ATCC).

Example cells include, but are not limited to, prokaryote, yeast, or higher eukaryote cells. Prokaryotic cells include eubacteria, such as Gram-negative or Gram-positive organisms, for example, Enterobacteriaceae such as Escherichia, e.g., E. coli, Enterobacter, Erwinia, Klebsiella, Proteus, Salmonella, e.g., Salmonella typhimurium, Serratia, e.g., Serratia marcescans, and Shigella, as well as Bacillus, such as B. subtilis and B. licheniformis, Pseudomonas, and Streptomyces. In some embodiments, eukaryotic microbes such as filamentous fungi or yeast cells are suitable cloning or expression of recombinant polypeptides. Saccharomyces cerevisiae, or common baker's yeast, is the most commonly used cell among lower eukaryotic microorganisms. However, a number of other genera, species, and strains are commonly available and useful herein, such as Pichia, e.g. P. pastoris, Schizosaccharomyces pombe; Kluyveromyces, Yarrowia; Candida; Trichoderma reesia; Neurospora crassa; Schwanniomyces, such as Schwanniomyces occidentalis; and filamentous fungi, such as, e.g., Neurospora, Penicillium, Tolypocladium, and Aspergillus cells such as A. nidulans and A. niger.

Vertebrate cells are also suitable for expressing recombinant proteins. Mammalian cell lines suitable for recombinant protein expression are well known in the art and include, but are not limited to, immortalized cell lines available from the American Type Culture Collection (ATCC), including, but not limited to, Chinese hamster ovary (CHO) cells, including CHOK1 cells (ATCC CCL61), DXB-11, DG-44, and Chinese hamster ovary cells/-DHFR (CHO, Urlaub et al., Proc. Natl. Acad. Sci. USA 77:4216, 1980); monkey kidney CV1 line transformed by SV40 (COS-7, ATCC CRL 1651); human embryonic kidney line (293 or 293 cells subcloned for growth in suspension culture, (Graham et al., J. Gen Virol. 36:59, 1977); baby hamster kidney cells (BHK, ATCC CCL 10); mouse sertoli cells (TM4, Mather, Biol. Reprod. 23:243-251, 1980); monkey kidney cells (CV1 ATCC CCL 70); African green monkey kidney cells (VERO-76, ATCC CRL-1587); human cervical carcinoma cells (HELA, ATCC CCL 2); canine kidney cells (MDCK, ATCC CCL 34); buffalo rat liver cells (BRL 3A, ATCC CRL 1442); human lung cells (W138, ATCC CCL 75); human hepatoma cells (Hep G2, HB 8065); mouse mammary tumor (MMT 060562, ATCC CCL51); TRI cells (Mather et al., Annals N.Y Acad. Sci. 383:44-68, 1982); MRC 5 cells or FS4 cells; mammalian myeloma cells, and a number of other cell lines. In some embodiments, the cells are selected from CHO cells.

In some embodiments, the cells are eukaryotic cells, such as, e.g., mammalian cells. The mammalian cells can be, for example, human or rodent or bovine cell lines or cell strains. Examples of such cells, cell lines, or cell strains include, but are not limited to, mouse myeloma (NSO)-cell lines, Chinese hamster ovary (CHO)-cell lines, FIT 1080, H9, HepG2, MCF7, MDBK Jurkat, NIH3T3, PC12, BF1K (baby hamster kidney cell), VERO, SP2/0, YB2/0, Y0, C127, L cell, COS, e.g., COS1 and COS7, QC1-3, HEK-293, VERO, PER.C6, HeLa, EB1, EB2, EB3, oncolytic, or hybridoma-cell lines. In some embodiments, the mammalian cells are CHO cell lines. In some embodiments, the mammalian cells are CHO cells. In some embodiments, the mammalian cells are selected from CHO-K1 cells, CHO-K1 SV cells, DG44 CHO cells, DUXB11 CHO cells, CHOS cells, CHO GS knock-out cells, CHO FUT8 GS knock-out cells, CHOZN cells, and CHO derived cells. In some embodiments, a CHO GS knock out cell (such as, e.g., a GSKO cell) is, for example, a CHO-K1 SV GS knockout cell. Additionally, the CHO FUT8 knockout cell is, for example, the Potelligent® CHOK1 SV (Lonza, Inc.). In some embodiments, the eukaryotic cells can also be avian cells, cell lines, or cell strains, such as, e.g., EBx® cells, EB14, EB24, EB26, EB66, or EBv13.

CHO cells, including CHOK1 cells (ATCC CCL61), are widely used to produce complex recombinant proteins. In some embodiments, the dihydrofolate reductase (DHFR) deficient mutant cell lines (Urlaub et al., 1980, Proc Natl Acad Sci USA 77:4216 4220), DXB11 and DG 44, are desirable CHO cell lines because the efficient DHFR selectable and amplifiable gene expression system allows high level recombinant protein expression in these cell lines (Kaufman R. J., 1990, Meth Enzymol 185:537-566). Also included are the glutamine synthase (GS)-knockout CHOK1SV cell lines, making use of glutamine synthetase (GS)-based methionine sulfoximine (MSX) selection. Other suitable CHO cells for use in a bioreactor of a manufacturing process of the present disclosure include, but are not limited to, the following (ECACC accession numbers in parenthesis): CHO (85050302); CHO (PROTEIN FREE) (00102307); CHO-K1 (85051005); CHO-K1/SF (93061607); CHO/dhFr-(94060607); CHO/dhFr-AC-free (05011002); and RR-CHOKI (92052129).

Large-scale production of proteins for commercial applications may be carried out in suspension culture. A variety of cells adapted to growth in suspension culture are known, including mouse myeloma NSO cells and CLIO cells from CFIO-S, DG44, and DXB11 cell lines. Other suitable cell lines include, but are not limited to, mouse myeloma SP2/0 cells, baby hamster kidney BF1K-21 cells, human PER.C6® cells, human embryonic kidney F1EK-293 cells, and cell lines derived or engineered from any of the cell lines disclosed herein.

In some embodiments, the eukaryotic cells are selected from lower eukaryotic cells, such as, e.g., yeast cells (e.g., Pichia genus (e.g., Pichia pastoris, Pichia methanolica, Pichia kluyveri, and Pichia angusta), Komagataella genus (e.g., Komagataella pastoris, Komagataella pseudopastoris, or Komagataella phaffii), cells of the Saccharomyces genus (e.g., Saccharomyces cerevisae, Saccharomyces kluyveri, Saccharomyces uvarum), cells of the Kluyveromyces genus (e.g., Kluyveromyces lactis, Kluyveromyces marxianus), cells of the Candida genus (e.g., Candida utilis, Candida cacaoi, Candida boidinii), cells of the Geotrichum genus (e.g., Geotrichum fermentans), Han-senula polymorpha, Yarrowia lipolytica, or Schizosaccharomyces pombe. In some embodiments, the eukaryotic cells are selected from Pichia pastoris strains. Non-limiting examples of Pichia pastoris strains include X33, GS115, KM71, KM71H, and CBS7435.

In some embodiments, the eukaryotic cells are selected from fungal cells (e.g., cells of Aspergillus (such as, e.g., A. niger, A. fumigatus, A. orzyae, A. nidula), Acremonium (such as, e.g., A. thermophilum), Chaetomium (such as, e.g., C. thermophilum), Chrysosporium (such as, e.g., C. thermophile), Cordyceps (such as, e.g., C. militaris), Corynascus, Ctenomyces, Fusarium (such as, e.g., F. oxysporum), Glomerella (such as, e.g., G. graminicola), Hypocrea (such as, e.g., H. jecorina), Magnaporthe (such as, e.g., M. orzyae), Myceliophthora (such as, e.g., M. thermophile), Nectria (such as, e.g., N. heamatococca), Neurospora (such as, e.g., N. crassa), Penicillium, Sporotrichum (such as, e.g., S. thermophile), Thielavia (such as, e.g., T. terrestris, T. heterothallica), Trichoderma (such as, e.g., T. reesei), or Verticillium (such as, e.g., V. dahlia).

In some embodiments, the eukaryotic cells are selected from insect cells (such as, e.g., Sf9, Mimic™ Sf9, Sf21, High Five™ (BT1-TN-5B1-4), or BT1-Ea88 cells), algae cells (such as, e.g., of the genus Amphora, Bacillariophyceae, Dunaliella, Chlorella, Chlamydomonas, Cyanophyta (cyanobacteria), Nannochloropsis, Spirulina, or Ochromonas), and plant cells (such as, e.g., cells from monocotyledonous plants (such as, e.g., maize, rice, wheat, or Setaria), or cells from a dicotyledonous plants (such as, e.g., cassava, potato, soybean, tomato, tobacco, alfalfa, Physcomitrella patens or Arabidopsis)).

Any type of recombinant protein, including proteins containing single polypeptide chains or multiple polypeptide chains, can be expressed by the cells. Recombinant proteins of the present disclosure include, but are not limited to, secreted proteins, non secreted proteins, intracellular proteins, or membrane-bound proteins. Illustratively, recombinant proteins can include, but are not limited to, cytokines, growth factors, hormones, muteins, fusion proteins, antibodies, antibody fragments, peptibodies, T-cell engaging molecules, and multi-specific antigen binding proteins. In some embodiments, the recombinant protein is a fusion protein.

In other embodiments, the recombinant protein to be purified according to a method of the present disclosure is an antigen-binding protein. Antigen-binding proteins include, but are not limited to, antibodies, peptibodies, antibody derivatives, antibody analogs, fusion proteins (including, e.g., single chain variable fragments (scFvs), double-chain (divalent) scFvs, and IgGscFv (see, e.g., Orcutt et al., 2010, Protein Eng Des Sel 23:221-228), hetero-IgGs (see, e.g., Liu et al., 2015, J Biol Chem 290:7535-7562), muteins, and XmAb® molecules (Xencor, Inc., Monrovia, CA). Additional antigen-binding proteins include, but are not limited to, bispecific T cell engagers (BiTE®) molecules, bispecific T cell engager molecules having extensions, such as, e.g., half-life extensions, such as, e.g., HLE BiTE® molecules, Heterolg BiTE® molecules, and others, chimeric antigen receptors (CARs, CAR Ts), and T cell receptors (TCRs). As used herein, the term “antigen-binding protein” refers to a protein or polypeptide that comprises an antigen-binding region or antigen-binding portion that has affinity for another molecule to which it binds (antigen). Antigen-binding proteins include, but are not limited to, antibodies, fusion proteins, VH, VHH, VL, (s) dAb, Fv, light chain (VL-CL), Fd (VH-CH1), heavy chain, Fab, Fab′, F(ab′) 2 or “r IgG” (“half antibody” consisting of a heavy chain and a light chain) or a modified antigen-binding portion of a full-length antibody, such as, e.g., a triple-chain antibody-like molecule, a heavy chain only antibody, single-chain variable fragment (scFv), di-scFv or bi(s) scFv, scFv-Fc, scFv-zipper, single-chain Fab (scFab), Fab2, Fab3, diabodies, single-chain diabodies, tandem diabodies (Tandabs), tandem di-scFv, tandem tri-scFv, “minibodies” exemplified by a structure which is as follows: (VH-VL-CH3)2, (scFv-CH3)2, ((scFv)2-CH3+CH3), ((scFv)2-CH3) or (scFv-CH3-scFv)2, multibodies, such as triabodies or tetrabodies, and single domain antibodies, such as nanobodies or single variable domain antibodies comprising merely one variable region, which might be VHH, VH, or VL, that specifically binds to an antigen or target independently of other variable regions or domains.

As used herein, the term “antibody” generally refers to a tetrameric immunoglobulin protein comprising two light chain polypeptides (about 25 kDa each) and two heavy chain polypeptides (about 50-70 kDa each).

As used herein, the term “light chain” or “immunoglobulin light chain” refers to a polypeptide comprising, from amino terminus (N-terminus) to carboxyl terminus (Cterminus), a single immunoglobulin light chain variable region (VL) and a single immunoglobulin light chain constant domain (CL). The immunoglobulin light chain constant domain (CL) can be a human kappa (κ) or human lambda (I) constant domain.

As used herein, the term “heavy chain” or “immunoglobulin heavy chain” refers to a polypeptide comprising, from amino terminus (N-terminus) to carboxyl terminus (Cterminus), a single immunoglobulin heavy chain variable region (VH), an immunoglobulin heavy chain constant domain 1 (CH1), an immunoglobulin hinge region, an immunoglobulin heavy chain constant domain 2 (CH2), an immunoglobulin heavy chain constant domain 3 (CH3), and optionally an immunoglobulin heavy chain constant domain 4 (CH4). Heavy chains are classified as mu (μ), delta (Δ), gamma (γ), alpha (α), and epsilon (ε), and define the antibody's isotype as IgM, IgD, IgG, IgA, and IgE, respectively. The IgG-class and IgA-class antibodies are further divided into subclasses, namely, IgG1, IgG2, IgG3, and IgG4, and IgA1 and IgA2, respectively. The heavy chains in IgG, IgA, and IgD antibodies have three constant domains (CH1, CH2, and CH3), whereas the heavy chains in IgM and IgE antibodies have four constant domains (CH1, CH2, CH3, and CH4). The immunoglobulin heavy chain constant domains can be from any immunoglobulin isotype, including subtypes. The antibody chains are linked together via inter-polypeptide disulfide bonds between the CL domain and the CH1 domain (i.e. between the light and heavy chain) and between the hinge regions of the two antibody heavy chains.

Variable regions of immunoglobulin chains generally exhibit the same overall structure, comprising relatively conserved framework regions (FR) joined by three hypervariable regions, more often called “complementarity determining regions” or CDRs. The CDRs from the two chains of each heavy chain and light chain pair typically are aligned by the framework regions to form a structure that binds specifically to a specific epitope on the target protein. From N-terminus to C-terminus, naturally-occurring light and heavy chain variable regions both typically conform with the following order of these elements: FR1, CDR1, FR2, CDR2, FR3, CDR3, and FR4. A numbering system has been devised for assigning numbers to amino acids that occupy positions in each of these domains. This numbering system is defined in Kabat Sequences of Proteins of Immunological Interest (1987 and 1991, NIH, Bethesda, MD), or Chothia & Lesk, 1987, J. Mol. Biol. 196:901-917; Chothia et al., 1989, Nature 342:878-883. The CDRs and FRs of a given antibody may be identified using this system. Other numbering systems for the amino acids in immunoglobulin chains include IMGT® (the international ImMunoGeneTics information system; Lefranc et al., Dev. Comp. Immunol. 29:185-203; 2005) and AHo (Honegger and Pluckthun, J. Mol. Biol. 309 (3): 657-670; 2001).

Papain digestion of antibodies produces two identical antigen-binding proteins, called “Fab” fragments, each with a single antigen-binding site, and a residual “Fc” fragment which contains all but the first domain of the immunoglobulin heavy chain constant region. The Fab fragment contains the variable domains from the light and heavy chains, as well as the constant domain of the light chain and the first constant domain (CH1) of the heavy chain. Thus, a “Fab fragment” is comprised of one immunoglobulin light chain (light chain variable region (VL) and constant region (CL)) and the CH1 domain and variable region (VH) of one immunoglobulin heavy chain. The heavy chain of a Fab molecule cannot form a disulfide bond with another heavy chain molecule. The “Fd fragment” comprises the VH and CH1 domains from an immunoglobulin heavy chain. The Fd fragment represents the heavy chain component of the Fab fragment.

The “Fc fragment” or “Fc region” of an immunoglobulin generally comprises two constant domains, a CH2 domain and a CH3 domain, and optionally comprises a CH4 domain. The Fc region may be an Fc region from an IgG1, IgG2, IgG3, or IgG4 immunoglobulin. In some embodiments, the Fc region comprises CH2 and CH3 domains from a human IgG1 or human IgG2 immunoglobulin. The Fc region may retain effector function, such as C1q binding, complement dependent cytotoxicity (CDC), Fc receptor binding, antibody-dependent cell-mediated cytotoxicity (ADCC), and phagocytosis. In other embodiments, the Fc region may be modified to reduce or eliminate effector function.

A “F(ab′) 2 fragment” is a bivalent fragment including two Fab′ fragments linked by a disulfide bridge between the heavy chains at the hinge region.

The “Fv” fragment is the minimum fragment that contains a complete antigen recognition and binding site from an antibody. This fragment consists of a dimer of one immunoglobulin heavy chain variable region (VH) and one immunoglobulin light chain variable region (VL) in tight, non-covalent association. It is in this configuration that the three CDRs of each variable region interact to define an antigen binding site on the surface of the VH-VL dimer. A single light chain or heavy chain variable region (or half of an Fv fragment comprising only three CDRs specific for an antigen) has the ability to recognize and bind antigen, although at a lower affinity than the entire binding site comprising both VH and VL.

A “single-chain variable fragment” or “scFv fragment” comprises the VH and VL regions of an antibody, wherein these regions are present in a single polypeptide chain, and optionally comprising a peptide linker between the VH and VL regions that enables the Fv to form the desired structure for antigen binding (see e.g., Bird et al., Science, Vol. 242:423-426, 1988; and Huston et al., Proc. Natl. Acad. Sci. USA, Vol. 85:5879-5883, 1988).

A “nanobody” is the heavy chain variable region of a heavy-chain antibody. Such variable domains are the smallest fully functional antigen-binding fragment of such heavy-chain antibodies with a molecular mass of only 15 kDa. See Cortez-Retamozo et al., Cancer Research 64:2853-57, 2004. Functional heavy-chain antibodies devoid of light chains are naturally occurring in certain species of animals, such as nurse sharks, wobbegong sharks, and Camelidae, such as camels, dromedaries, alpacas and llamas. The antigen-binding site is reduced to a single domain, the VHH domain, in these animals. These antibodies form antigen-binding regions using only heavy chain variable region, i.e., these functional antibodies are homodimers of heavy chains only having the structure H2L2 (referred to as “heavy-chain antibodies” or “HCAbs”). Camelized VHH reportedly recombines with IgG2 and IgG3 constant regions that contain hinge, CH2, and CH3 domains and lack a CH1 domain. Camelized VHH domains have been found to bind to antigen with high affinity (Desmyter et al., J. Biol. Chem., Vol. 276:26285-90, 2001) and possess high stability in solution (Ewert et al., Biochemistry, Vol. 41:3628-36, 2002). Methods for generating antibodies having camelized heavy chains are described in, for example, U.S. Patent Publication Nos. 2005/0136049 and 2005/0037421. Alternative scaffolds can be made from human variable-like domains that more closely match the shark V-NAR scaffold and may provide a framework for a long penetrating loop structure.

As used herein, the term “heavy chain-only antibody” refers to an immunoglobulin protein consisting of two heavy chain polypeptides (such as, e.g., heavy chain polypeptides that are about 50-70 kDa each). A “heavy chain-only antibody” lacks the two light chain polypeptides found in a conventional antibody. Heavy-chain antibodies constitute aboutone fourth of the IgG antibodies produced by the camelids, e.g., camels and llamas (Hamers-Casterman C., et al. Nature. 363, 446-448 (1993)). These molecules are formed by two heavy chains but are devoid of light chains. As a consequence, the variable antigen binding part is referred to as the VHH domain, and it represents the smallest naturally occurring, intact, antigen-binding site, being only around 120 amino acids in length (Desmyter, A., et al. J. Biol. Chem. 276, 26285-26290 (2001). Heavy chain antibodies with a high specificity and affinity can be generated against a variety of antigens through immunization (van der Linden, R. H., et al. Biochim. Biophys. Acta. 1431, 3746 (1999), and the VHH portion can be readily cloned and expressed in yeast (Frenken, L. G. J., et al. J. Biotechnol. 78, 11-21 (2000). Their levels of expression, solubility and stability are significantly higher than those of classical F(ab) or Fv fragments (Ghahroudi, M. A. et al. FEBS Lett. 414, 521-526 (1997). Sharks have also been shown to have a single VH-like domain in their antibodies, termed VNAR. (Nuttall et al. Eur. J. Biochem. 270, 3543-3554 (2003); Nuttall et al. Function and Bioinformatics 55, 187-197 (2004); Dooley et al., Molecular Immunology 40, 25-33 (2003).)

In some embodiments, a “heavy chain-only antibody” is a dimeric antibody comprising a VH antigenbinding domain and the CH2 and CH3 constant domains, in the absence of the CH1 domain. In some embodiments, a heavy chainonly antibody is composed of a variable region antigenbinding domain composed of framework 1, CDR1, framework 2, CDR2, framework 3, CDR3, and framework 4. In some embodiments, a heavy chain-only antibody is composed of an antigen-binding domain, at least part of a hinge region, and CH2 and CH3 domains. In some embodiments, a heavy chain-only antibody is composed of an antigen-binding domain, at least part of a hinge region, and a CH2 domain. In some embodiments, a heavy chain-only antibody is composed of an antigen-binding domain, at least part of a hinge region, and a CH3 domain. Heavy chain-only antibodies in which the CH2 and/or CH3 domain is truncated are also included herein. The heavy chainonly antibodies described herein may belong to the IgG subclass, but heavy chain-only antibodies belonging to other subclasses, such as IgM, IgA, IgD and IgE subclass, are also included herein. In some embodiments, a heavy chain-only antibody may belong to the IgG1, IgG2, IgG3, or IgG4 subtype, e.g., the IgG1 or IgG4 subtype. In some embodiments, a heavy chain antibody only is of the IgG1 or IgG4 subtype, wherein one or more of the CH domains is modified to alter an effector function of the antibody. In some embodiments, a heavy chain-only antibody is of the IgG4 subtype, wherein one or more of the CH domains is modified to alter an effector function of the antibody. In some embodiments, a heavy chain-only antibody is of the IgG1 subtype, wherein one or more of the CH domains is modified to alter an effector function of the antibody. Modifications of CH domains that alter effector function are further described herein. Non-limiting examples of heavy-chain-only antibodies are described, for example, in WO2018/039180, the disclosure of which is incorporated herein by reference herein in its entirety.

As used herein, the term “three-chain antibody like molecule” or “TCA” refers to an antibody-like molecule comprising, consisting essentially of, or consisting of three polypeptide subunits, two of which comprise, consist essentially of, or consist of one heavy and one light chain of a monoclonal antibody, or antigen-binding fragments of such antibody chains, comprising an antigen-binding region and at least one CH domain. This heavy chain/light chain pair has binding specificity for a first antigen. The third polypeptide subunit comprises, consists essentially of, or consists of a heavy-chain only antibody comprising an Fc portion comprising CH2 and/or CH3 and/or CH4 domains, in the absence of a CH1 domain, and one or more antigen binding domains (such as, e.g., two antigen binding domains) that binds an epitope of a second antigen or a different epitope of the first antigen, where such binding domain is derived from or has sequence identity with the variable region of an antibody heavy or light chain. Parts of such variable region may be encoded by VH and/or VL gene segments, D and JH gene segments, or JL gene segments. The variable region may be encoded by rearranged VHDJH, VLDJH, VHJL, or VLJL gene segments.

In some embodiments, the antigen-binding protein binds to one of more of the following, alone or in any combination: CD proteins including, but not limited to, CD3, CD4, CD5, CD7, CD8, CD19, CD20, CD22, CD25, CD30, CD33, CD34, CD38, CD40, CD70, CD123, CD133, CD138, CD171, and CD174, HER receptor family proteins, including, for instance, HER2, HER3, HER4, and the EGF receptor, EGFRvIII, cell adhesion molecules, for example, LFA-1, Mol, p150,95, VLA-4, ICAM-1, VCAM, and alpha v/beta 3 integrin, growth factors, including but not limited to, for example, vascular endothelial growth factor (“VEGF”); VEGFR2, growth hormone, thyroid stimulating hormone, follicle stimulating hormone, luteinizing hormone, growth hormone releasing factor, parathyroid hormone, mullerian-inhibiting substance, human macrophage inflammatory protein (MIP-1-alpha), erythropoietin (EPO), nerve growth factor, such as NGF-beta, platelet-derived growth factor (PDGF), fibroblast growth factors, including, for instance, aFGF and bFGF, epidermal growth factor (EGF), Cripto, transforming growth factors (TGF), including, among others, TGF-α and TGF-β, including TGF-β1, TGF-β2, TGF-β3, TGF-β4, or TGF-β5, insulin-like growth factors-I and -II (IGF-I and IGF-II), des (1-3)-IGF-I (brain IGF-I), and osteoinductive factors, insulins and insulin-related proteins, including, but not limited to, insulin, insulin A chain, insulin B-chain, proinsulin, and insulin-like growth factor binding proteins; (coagulation and coagulation-related proteins, such as, among others, factor VIII, tissue factor, von Willebrand factor, protein C, alpha-1-antitrypsin, plasminogen activators, such as urokinase and tissue plasminogen activator (“t-PA”), bombazine, thrombin, thrombopoietin, and thrombopoietin receptor, colony stimulating factors (CSFs), including the following, among others, M-CSF, GM-CSF, and G-CSF, other blood and serum proteins, including but not limited to albumin, IgE, and blood group antigens, receptors and receptor-associated proteins, including, for example, flk2/flt3 receptor, obesity (OB) receptor, growth hormone receptors, and T-cell receptors; neurotrophic factors, including but not limited to, bone-derived neurotrophic factor (BDNF) and neurotrophin-3, −4, −5, or −6 (NT-3, NT-4, NT-5, or NT-6); relaxin A-chain, relaxin B-chain, and prorelaxin, interferons, including for example, interferon-alpha, -beta, and -gamma, interleukins (ILs), e.g., IL-1 to IL-10, IL-12, IL-15, IL-17, IL-23, IL-12/IL-23, IL-2Ra, IL1-R1, IL-6 receptor, IL-4 receptor and/or IL-13 to the receptor, IL-13RA2, or IL-17 receptor, IL-1RAP; viral antigens, including but not limited to, an AIDS envelope viral antigen, lipoproteins, calcitonin, glucagon, atrial natriuretic factor, lung surfactant, tumor necrosis factor-alpha and -beta, enkephalinase, BCMA, IgKappa, ROR-1, ERBB2, mesothelin, RANTES (regulated on activation normally T-cell expressed and secreted), mouse gonadotropin-associated peptide, DNase, FR-alpha, inhibin, and activin, integrin, protein A or D, rheumatoid factors, immunotoxins, bone morphogenetic protein (BMP), superoxide dismutase, surface membrane proteins, decay accelerating factor (DAF), AIDS envelope, transport proteins, homing receptors, MIC (MIC-a, MIC-B), ULBP 1-6, EPCAM, addressins, regulatory proteins, immunoadhesins, antigen-binding proteins, somatropin, CTGF, CTLA4, eotaxin-1, MUC1, CEA, c-MET, Claudin-18, GPC-3, EPHA2, FPA, LMP1, MG7, NY-ESO-1, PSCA, ganglioside GD2, ganglioside GM2, BAFF, OPGL (RANKL), myostatin, Dickkopf-1 (DKK-1), Ang2, NGF, IGF-1 receptor, hepatocyte growth factor (HGF), TRAIL-R2, c-Kit, B7RP-1, PSMA, NKG2D-1, programmed cell death protein 1 and ligand, PD1 and PDL1, mannose receptor/hCGB, hepatitis-C virus, mesothelin dsFv [PE38] conjugate, Legionella pneumophila (IIy), IFN gamma, interferon gamma induced protein 10 (IP10), IFNAR, TALL-1, thymic stromal lymphopoietin (TSLP), proprotein convertase subtilisin/Kexin Type 9 (PCSK9), stem cell factors, Flt-3, calcitonin gene-related peptide (CGRP), OX40L, α4β7, platelet specific (platelet glycoprotein IIb/IIIb (PAC-1), transforming growth factor beta (TFGβ), Zona pellucida sperm-binding protein 3 (ZP-3), TWEAK, platelet derived growth factor receptor alpha (PDGFRα), sclerostin, and biologically active fragments or variants of any of the foregoing.

In other embodiments, the recombinant protein to be purified according to a method of the present disclosure is an antibody. In some embodiments, the antibody is a human antibody.

In some embodiments, the antibody is selected from abrilumab, brazikumab, brodalumab, crizanlizumab, denosumab, eculizumab, erenumab, evolocumab, fremanezumab, meplazumab, nemolizumab, ontamalimab, panitumumab, prezalumab, ravulizumab, rilotumumab, romosozumab, satralizumab, tafolecimab, tanezumab, tezepelumab, tremelimumab, utomilumab, and volagidemab. In some embodiments, the antibody is selected from denosumab, erenumab, evolocumab, panitumumab, romosozumab, and tezepelumab. In some embodiments, the antibody is denosumab. In some embodiments, the antibody is erenumab. In some embodiments, the antibody is evolocumab. In some embodiments, the antibody is panitumumab. In some embodiments, the antibody is romosozumab. In some embodiments, the antibody is tezepelumab.

In some embodiments, the antibody is an IgG1 antibody. In some embodiments, the antibody is a human IgG1 antibody.

In some embodiments, the antibody is an IgG4 antibody. In some embodiments, the antibody is a human IgG4 antibody.

In some embodiments, the antibody is an IgG2 antibody. In some embodiments, the antibody is a human IgG2 antibody.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

### Aspects

1. A computer-implemented method, comprising: obtaining, by one or more processors, a first image captured by a bright-field microscope having a first field of view including one or more cells distributed between one or more pen regions; obtaining, by the one or more processors, a second image captured by a fluorescence microscope having a second field of view including the one or more cells distributed between the one or more pen regions; analyzing, by one or more processors, the first image using an image segmentation technique to identify areas in the first image corresponding to locations of cells; generating, by the one or more processors, a first image mask based on the identified areas in each of the pen regions of the first image corresponding to locations of cells; generating, by the one or more processors, a second image mask, corresponding to locations without cells in each of the pen regions of the first image, based on inverting the first image mask; applying, by the one or more processors, the first image mask and the second image mask to the second image; analyzing, by the one or more processors, each of the pen regions of the second image to determine an indication of a first pixel intensity corresponding to the first image mask for each pen region, and a second pixel intensity corresponding to the second image mask for each pen region; and identifying, by the one or more processors, an indication of a cell population of each of the one or more pen regions based on the first pixel intensity and the second pixel intensity.
2. The computer-implemented method of aspect 1, wherein generating the second image mask includes expanding the first image mask and inverting the expanded first image mask.
3. The computer-implemented method of any one of aspects 1 or 2, wherein the first image and the second image are captured within a threshold period of time.
4. The computer-implemented method of any one of aspects 1-3, further comprising: obtaining, by the one or more processors, a third image of the one or more pen regions captured by the fluorescence microscope prior to the one or more cells being distributed between the one or more pen regions.
5. The computer-implemented method of claim 5, wherein identifying the indication of the cell population of each of the one or more pen regions is further based on a third pixel intensity corresponding to each pen region of the third image.
6. A system, comprising: one or more pen regions; a bright-field microscope having a first field of view including one or more cells distributed between one or more pen regions, configured to capture a first image; a fluorescence microscope having a second field of view including the one or more cells distributed between the one or more pen regions, configured to capture a second image; one or more processors; and a memory storing non-transitory, computer-readable instructions, that, when executed by the one or more processors, cause the one or more processors to: analyze the first image using an image segmentation technique to identify areas in the first image corresponding to locations of cells; generate a first image mask based on the identified areas in each of the pen regions of the first image corresponding to locations of cells; generate a second image mask, corresponding to locations without cells in each of the pen regions of the first image, based on inverting the first image mask; apply the first image mask and the second image mask to the second image; analyze each of the pen regions of the second image to determine an indication of a first pixel intensity corresponding to the first image mask for each pen region, and a second pixel intensity corresponding to the second image mask for each pen region; and identify an indication of a cell population of each of the one or more pen regions based on the first pixel intensity and the second pixel intensity.
7. The system of aspect 6, wherein generating the second image mask includes expanding the first image mask and inverting the expanded first image mask.
8. The system of any one of aspects 6 or 7, wherein the first image and the second image are captured within a threshold period of time.
9. The system of any one of aspects 6-8, wherein the fluorescence microscope is further configured to capture a third image of the one or more pen regions prior to the one or more cells being distributed between the one or more pen regions.
10. The computer-implemented method of aspect 9, wherein identifying the indication of the cell population of each of the one or more pen regions is further based on a third pixel intensity corresponding to each pen region of the third image.
11. A non-transitory, computer-readable medium storing instructions that, when executed by one or more processors, cause the one or more processors to: obtain a first image captured by a bright-field microscope having a first field of view including one or more cells distributed between one or more pen regions; obtain a second image captured by a fluorescence microscope having a second field of view including the one or more cells distributed between the one or more pen regions; analyze the first image using an image segmentation technique to identify areas in the first image corresponding to locations of cells; generate a first image mask based on the identified areas in each of the pen regions of the first image corresponding to locations of cells; generate a second image mask, corresponding to locations without cells in each of the pen regions of the first image, based on inverting the first image mask; apply the first image mask and the second image mask to the second image; analyze each of the pen regions of the second image to determine an indication of a first pixel intensity corresponding to the first image mask for each pen region, and a second pixel intensity corresponding to the second image mask for each pen region; and identify an indication of a cell population of each of the one or more pen regions based on the first pixel intensity and the second pixel intensity.
12. The non-transitory, computer-readable medium of aspect 11, wherein generating the second image mask includes expanding the first image mask and inverting the expanded first image mask.
13. The non-transitory, computer-readable medium of any one of aspects 11 or 12, wherein the first image and the second image are captured within a threshold period of time.
14. The non-transitory, computer-readable medium of any one of aspects 11-13, wherein the instructions further include instructions causing the one or more processors to obtain a third image of the one or more pen regions captured by the fluorescence microscope prior to the one or more cells being distributed between the one or more pen regions.
15. The non-transitory, computer-readable medium of aspect 14, wherein identifying the indication of the cell population of each of the one or more pen regions is further based on a third pixel intensity corresponding to each pen region of the third image.

1. A computer-implemented method, comprising:
obtaining, by one or more processors, a first image captured by a bright-field microscope having a first field of view including one or more cells distributed between one or more pen regions;
obtaining, by the one or more processors, a second image captured by a fluorescence microscope having a second field of view including the one or more cells distributed between the one or more pen regions;
analyzing, by one or more processors, the first image using an image segmentation technique to identify areas in the first image corresponding to locations of cells;
generating, by the one or more processors, a first image mask based on the identified areas in each of the pen regions of the first image corresponding to locations of cells;
generating, by the one or more processors, a second image mask, corresponding to locations without cells in each of the pen regions of the first image, based on inverting the first image mask;
applying, by the one or more processors, the first image mask and the second image mask to the second image;
analyzing, by the one or more processors, each of the pen regions of the second image to determine an indication of a first pixel intensity corresponding to the first image mask for each pen region, and a second pixel intensity corresponding to the second image mask for each pen region; and
identifying, by the one or more processors, an indication of a cell population of each of the one or more pen regions based on the first pixel intensity and the second pixel intensity.

2. The computer-implemented method of claim 1, wherein generating the second image mask includes expanding the first image mask and inverting the expanded first image mask.

3. The computer-implemented method of claim 1, wherein the first image and the second image are captured within a threshold period of time.

4. The computer-implemented method of claim 1, further comprising:
obtaining, by the one or more processors, a third image of the one or more pen regions captured by the fluorescence microscope prior to the one or more cells being distributed between the one or more pen regions.

5. The computer-implemented method of claim 4, wherein identifying the indication of the cell population of each of the one or more pen regions is further based on a third pixel intensity corresponding to each pen region of the third image.

6. A system, comprising:
one or more pen regions;
a bright-field microscope having a first field of view including one or more cells distributed between one or more pen regions, configured to capture a first image;
a fluorescence microscope having a second field of view including the one or more cells distributed between the one or more pen regions, configured to capture a second image;
one or more processors; and
a memory storing non-transitory, computer-readable instructions, that, when executed by the one or more processors, cause the one or more processors to:
analyze the first image using an image segmentation technique to identify areas in the first image corresponding to locations of cells;
generate a first image mask based on the identified areas in each of the pen regions of the first image corresponding to locations of cells;
generate a second image mask, corresponding to locations without cells in each of the pen regions of the first image, based on inverting the first image mask;
apply the first image mask and the second image mask to the second image;
analyze each of the pen regions of the second image to determine an indication of a first pixel intensity corresponding to the first image mask for each pen region, and a second pixel intensity corresponding to the second image mask for each pen region; and
identify an indication of a cell population of each of the one or more pen regions based on the first pixel intensity and the second pixel intensity.

7. The system of claim 6, wherein generating the second image mask includes expanding the first image mask and inverting the expanded first image mask.

8. The system of claim 6, wherein the first image and the second image are captured within a threshold period of time.

9. The system of claim 6, wherein the fluorescence microscope is further configured to capture a third image of the one or more pen regions prior to the one or more cells being distributed between the one or more pen regions.

10. The system of claim 9, wherein identifying the indication of the cell population of each of the one or more pen regions is further based on a third pixel intensity corresponding to each pen region of the third image.

11. A non-transitory, computer-readable medium storing instructions that, when executed by one or more processors, cause the one or more processors to:
obtain a first image captured by a bright-field microscope having a first field of view including one or more cells distributed between one or more pen regions;
obtain a second image captured by a fluorescence microscope having a second field of view including the one or more cells distributed between the one or more pen regions;
analyze the first image using an image segmentation technique to identify areas in the first image corresponding to locations of cells;
generate a first image mask based on the identified areas in each of the pen regions of the first image corresponding to locations of cells;
generate a second image mask, corresponding to locations without cells in each of the pen regions of the first image, based on inverting the first image mask;
apply the first image mask and the second image mask to the second image;
analyze each of the pen regions of the second image to determine an indication of a first pixel intensity corresponding to the first image mask for each pen region, and a second pixel intensity corresponding to the second image mask for each pen region; and
identify an indication of a cell population of each of the one or more pen regions based on the first pixel intensity and the second pixel intensity.

12. The non-transitory, computer-readable medium of claim 11, wherein generating the second image mask includes expanding the first image mask and inverting the expanded first image mask.

13. The non-transitory, computer-readable medium of claim 11, wherein the first image and the second image are captured within a threshold period of time.

14. The non-transitory, computer-readable medium of claim 11, wherein the instructions further include instructions causing the one or more processors to obtain a third image of the one or more pen regions captured by the fluorescence microscope prior to the one or more cells being distributed between the one or more pen regions.

15. The non-transitory, computer-readable medium of claim 14, wherein identifying the indication of the cell population of each of the one or more pen regions is further based on a third pixel intensity corresponding to each pen region of the third image.

16. (canceled)

17. (canceled)

18. (canceled)

19. (canceled)

20. (canceled)

21. The computer-implemented method of claim 1, further comprising applying the corresponding fluorescence images in order to measure fluorescence intensity of individual cells grown on the chip.

22. The computer-implemented method of claim 1, wherein the image based analysis is scoring fluorescence intensity of cells stained on a chip.

23. The computer-implemented method of claim 22, wherein cells are profiled based on fluorescence intensity.

24. The computer-implemented method of claim 1, wherein the cells express a recombinant protein.

25. The computer-implemented method of claim 24, wherein the recombinant protein is a therapeutic biologic.

26. The computer-implemented method of claim 1, wherein the image-based analysis is a component of cell line development.

27. The computer-implemented method of claim 26, wherein cells are selected based on the indication of the cell population.

28. The computer-implemented method of claim 27, wherein clonal cell lines made from the selected cells are used as host cells expressing the recombinant protein.

29. (canceled)
